(19) United States
(12) Patent Application Publication
(10) Pub. No.: US 2016/0179030 A1
(43) Pub. Date: Jun. 23, 2016

(54) ILLUMINATOR HAVING A SHEET EMITTER AND DEFINING AN OPTICAL CAVITY

(71) Applicant: Xerox Corporation, Norwalk, CT (US)

(72) Inventor: Robert Paul Herloski, Webster, NY (US)

(21) Appl. No.: 14/574,470

(22) Filed: Dec. 18, 2014

(51) Int. Cl. G03G 15/04; F21V 7/04

(52) U.S. Cl. CPC G03G 15/04036; F21V 7/043; F21Y 2105/008

(57) ABSTRACT

An illuminator useful in illuminating an image bearing surface, comprising a flexible sheet emitter including an emitting layer, the emitting layer emits light. The sheet emitter has a first face and a second face opposite the first face, and is substantially transparent. The illuminator has a diffusely reflecting surface shaped to form an optical cavity. The emitter is disposed in the cavity with the first face facing the reflecting surface, the cavity extending along a longitudinal axis. In cross section, the reflecting surface having an aperture through which the light exits the cavity, and at least one rigid element extending in the direction of the longitudinal axis, the emitter being mechanically coupled to the at least one rigid element to facilitate directing of light from the emitting layer into the cavity and out of the aperture. The illuminator may be in a copier or printer.

### TECHNICAL FIELD

An illuminator having a sheet emitter and defining a cavity, for illuminating an image bearing surface.

### BACKGROUND

In a printing system (also referred to herein as a “printer”) or a copier system (also referred to herein as a “copier”), an image input module is used to measure reflection from an image bearing surface and from test patches on the image bearing surface. Often, these image input modules are referred to as densitometers, as they are imaging the image bearing surface to detect the toner deposition or lack thereof on the image bearing surface. These measured reflections are used for calibration of the printer.

In prior systems, the image input module used a fluorescent lamp or a rare gas lamp for illuminating the image bearing surface and the test patches. In such systems, the fluorescent lamp or the rare gas lamp used for illumination is a continuous source of light in the cross-process (or fast scan) direction. However, fluorescent lamps and rare gas lamps are relatively expensive. More recently, systems have employed discrete light emitting diodes (LEDs) which are located on a conventional printed circuit board. However, the light output from such systems is limited by the layout and emitting efficiency and uniformity of the LEDs.

### SUMMARY

An aspect of the disclosure is directed to an illuminator useful in illuminating an image bearing surface. The illuminator comprises a flexible sheet emitter including an emitting layer, the emitting layer adapted to emit light, the sheet emitter having a first face and a second face opposite the first face, the emitting layer being substantially transparent to the light. The illuminator also comprises a reflecting surface shaped to form an optical cavity for the light, the reflecting surface adapted to diffusely reflect the light, the emitter being disposed in the cavity with the first face facing the reflecting surface, the cavity extending along a longitudinal axis, in cross section transverse to the longitudinal axis, the reflecting surface having a non-closed shape along at least a portion of the longitudinal axis thereby defining an aperture through which the light exits the cavity; and the illuminator comprises at least one rigid element extending in the direction of the longitudinal axis, the emitter being mechanically coupled to the at least one rigid element to facilitate directing of light from the emitting layer into the cavity and out of the aperture.

In some embodiments, the emitter is connected to the at least one rigid element. The emitter may be connected to the at least one rigid element along an entire width of the sheet emitter, the connection occurring along at least a portion of the longitudinal axis. The connection may be a direct connection.

In some embodiments, the emitter extends less than 360 degrees around the longitudinal axis.

The emitter may be connected to one of the at least one rigid elements at a plurality of discrete locations along a width of the sheet emitter.

In some embodiments, the emitter is an OLED emitter.

In some embodiments, the rigid element has an element surface having a substantially cylindrical cross section transverse to the longitudinal axis, the mechanical coupling of the emitter being to the element surface. The element surface may be cylindrical.

In some embodiments, the reflecting surface has a substantially cylindrical cross section transverse to the longitudinal axis. The reflecting surface may have a cylindrical cross section transverse to the longitudinal axis.

In some embodiments, the rigid element has an element surface to which the mechanically coupling of the emitter occurs, the element surface being an exterior surface of the rigid element, the second face facing the element surface. The element surface and the second face may be directly connected together. The reflecting surface and the first face may be directly connected together. The rigid element may have a substantially cylindrical cross section and the reflecting surface has a substantially cylindrical cross section.

In some embodiment, the rigid element has an element surface to which the mechanically coupling of the emitter occurs, the element surface being an interior surface of the rigid element, the first face facing the element surface. The element surface and the first face may be directly connected together. The reflecting surface and the first face may be directly connected together.

The at least one rigid element may have a substantially cylindrical cross section and the reflecting surface has a substantially cylindrical cross section.

Another aspect of the disclosure is directed to a printer or electronic copier, comprising a print engine configured to apply a marking medium to an image bearing surface and a system for illuminating the image bearing surface in the printer or electronic copier. The system comprises (i) an illuminator, comprising (a.) a flexible sheet emitter including an emitting layer, the emitting layer adapted to emit light, the emitter having a first face and a second face opposite the first face, the emitting layer being transparent to the light, (b.) a reflecting surface shaped to form an optical cavity for the light, the reflecting surface adapted to diffusely reflect the light, the emitter being disposed in the cavity with the first face facing the reflecting surface, the cavity extending along a longitudinal axis, in cross section transverse to the longitudinal axis, the reflecting surface having a non-closed shape along at least a portion of the longitudinal axis thereby defining an aperture through which the light exits the cavity, and (c.) at least one rigid element extending in the direction of the longitudinal axis, the emitter being mechanically coupled to the at least one rigid element to facilitate directing of light from the emitting layer into the cavity and out of the aperture, and (ii) a light sensor positioned relative to the image bearing surface such that at least one of a specular portion and a diffuse portion of the light reflecting from the image bearing surface is received by the light sensor.

The term “mechanically coupling” as used herein means fastening of two objects indirectly or directly such that a first of the objects (e.g., a surface of a rigid object) is able to facilitate maintenance of or to maintain a shape of a second of the objects (e.g., a flexible object). Mechanical coupling may allow for some independent movement of the second object relative to first object at a location where the first object and the second object are mechanically coupled together if a force is applied to the second object at the location.

The term “connected” as used herein means fastening of two objects indirectly or directly such that a first of the objects (e.g., a rigid object) is able to maintain a shape of a second of the objects (e.g., a flexible object) but independent movement of the second object relative to first object is not possible at least at locations of the connection.

The term “directly connected” as used herein means that two objects are “connected” such that the first object and the second object contact one another, with only adhesive possibly intervening.

The term “substantially transparent” as used herein means a characteristic of a medium indicating that at least some light rays travel straight through the medium. A transparent medium may be only partially transparent and allows for the possibility that the medium is partially translucent (i.e., at least partially diffusely transmissive).

The term “substantially cylindrical” as used herein means having a surface extending along a longitudinal axis and curved to have a cross section transverse to the longitudinal axis that is round or oval or polygonal in shape, or a continuous or discrete approximation of said shapes.

### BRIEF DESCRIPTION OF THE SEVERAL VIEWS OF THE DRAWING

The nature and mode of operation of the present disclosure will now be more fully described in the following detailed description of the disclosure taken with the accompanying drawing figures, in which:

FIG. 1A illustrates a conventional illuminator comprising a sheet emitter projecting light onto a point:

FIG. 1B illustrates illuminator configured such that a diffusely reflecting surface is shaped to form an optical cavity with an aperture and having a sheet emitter disposed in the cavity;

FIG. 1C is a graphical representation of the ratio of the irradiance (at a point) from a sheet emitter when it is cylindrically shaped to when the sheet emitter is shaped as a flat source;

FIG. 2A is a schematic illustration of an example of an sheet emitter for use with the present disclosure;

FIG. 2B is a schematic, cross-sectional illustration of an example of the sheet emitter of FIG. 2A:

FIG. 3A is a schematic illustration of an example of an illuminator according to aspects of the present disclosure;

FIG. 3B is a cross-sectional view along line 3B-3B of the illuminator of FIG. 3A;

FIG. 4 is an image input module of a printer, the module having an illuminator and a sensor according to aspects of the present disclosure;

FIGS. 5-9 are cross-sectional schematic illustrations of examples of illuminators according to aspects of the present disclosure, which like the embodiment of FIG. 3B extend into and out of the paper;

FIG. 10 is a schematic illustration of an illuminator of FIG. 3A-8 in an image input module of a printer or copier according to aspects of the present disclosure; and

FIG. 11 is a simplified, schematic illustration of basic elements of a xerographic color printer according to aspects of the present disclosure.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Aspects of the present disclosure are directed to techniques for increasing irradiance from a sheet illuminator. As described in greater detail below, sheet emitters, such as OLEDs, are known. According to aspects of the present disclosure, a diffusely reflecting surface is shaped to form an optical cavity with an aperture, and the sheet illuminator is located within the cavity. The light from the sheet illuminator is reflected from the wall(s) of the cavity and out through the aperture. As discussed below, the light from the cavity projected onto a surface from a given distance can have a greater irradiance at the surface than the light projected from the given distance onto the surface by the sheet illuminator when it is flat state.

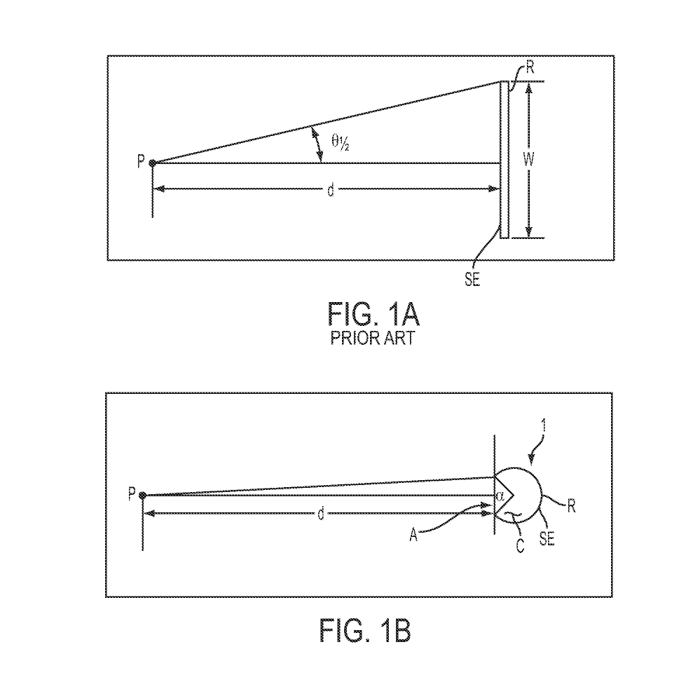

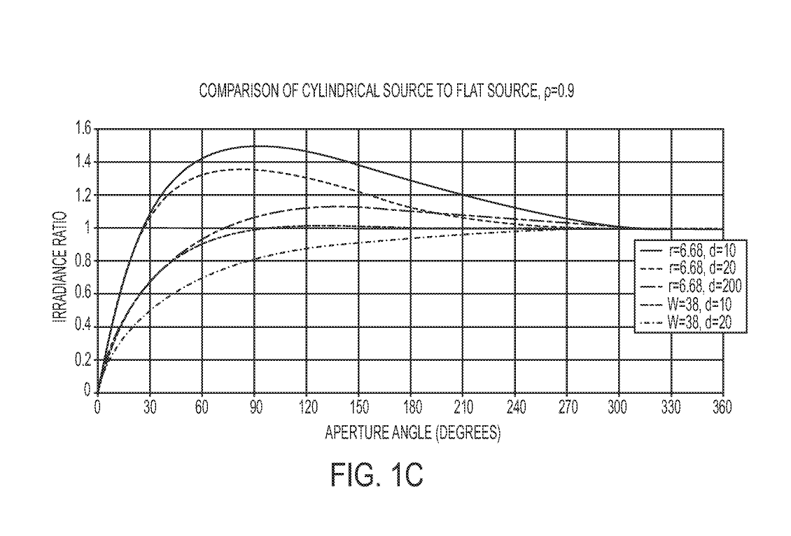

FIG. 1A illustrates a sheet emitter SE projecting light onto a point P a distance d from the sheet emitter. A reflecting surface R is attached to an outer surface of the sheet emitter SE to reflect some of the light from the sheet emitter that would otherwise be directed away from point P, toward point P. The sheet emitter has a width W and a length (extending in and out of the paper) that is much greater than width W. Half of the width W subtends an angle Θ_{1/3} relative to point P. The sheet has a radiance N₀. The irradiance of sheet emitter SE provided at point P can be calculated using the following equation.

H₀≈π*N₀*(1+ρ)*sin(Θ_{1/2}) Eqn. 1

FIG. 1B illustrates illuminator 1 comprising a sheet emitter SE having a reflecting surface R attached to the sheet emitter according to aspects of the present disclosure. The illuminator is shaped such that diffusely reflecting surface R is shaped to form an optical cavity C with an aperture A, the sheet emitter disposed in the cavity. Other than being shaped to form optical cavity C, the sheet emitter and the reflecting surface are the same as shown in FIG. 1A. The illuminator forms a cylinder extending into and out of the paper in FIG. 1B. Aperture A extends over an angle α measured from the center of the cylinder. Surface R has a reflectivity p. The irradiance of illuminator 1 provided at point P can be calculated using the theory of Spencer and Montgomery as set forth in D. E. Spencer and L. L. Montgomery. “Cylindrical Aperture Lamps,” Journal of the Optical Society of America. Vol. 51, No. 7 pgs. 727-730 (1961).

FIG. 1C is a graphical representation of the ratio of the calculated irradiance at the point P when it is cylindrically shaped relative to the calculated irradiance when it is a flat source, both located a distance d from point P. The reflectivity of the diffusely reflecting surface is assumed to be 0.9. The ratio is plotted as a function of aperture angle α. In the graph there are two sets of data. For the first set of data, the radius r of the cylinder has been kept constant And the corresponding width W (where W=r*(2π−α)) is used for the calculation of radiance of the flat source. It will be appreciated that because radius r is constant and angle α is varied, the width of the sheet emitter varies for each angle α. Accordingly, the width W of the flat sheet emitter used in calculation of the irradiances, when r is constant, is changed for each angle α, such that the width of the flat sheet emitter is equal to the width of the sheet emitter of the cylindrical illuminator. For the second set of data, the width W of the sheet emitter has been kept constant for the sheet emitter and the corresponding radius r (where r=W/(2π−α)) of the cylindrical illuminator is varied for each angle α.

According to aspects of the disclosure, it has been discovered that by providing a sheet emitter (e.g., a flexible sheet emitter) with a reflecting surface configured to form a cavity, the irradiance at a surface (e.g., an image bearing surface of a copier or a printer) can be increased over what can be provided by a corresponding flat sheet emitter having a reflecting surface. It will be appreciated that, for certain aperture angles α and distance d, the cylindrical source provides a substantial increase in irradiance at surface S over the equivalent flat sheet emitter.

According to aspects of the present disclosure, a sheet emitter is incorporated into an illuminator having a cavity C as set forth below.

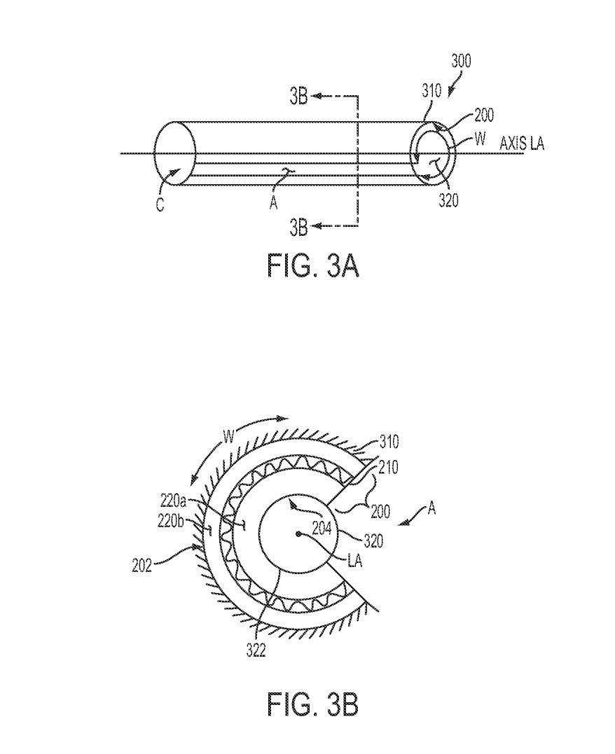

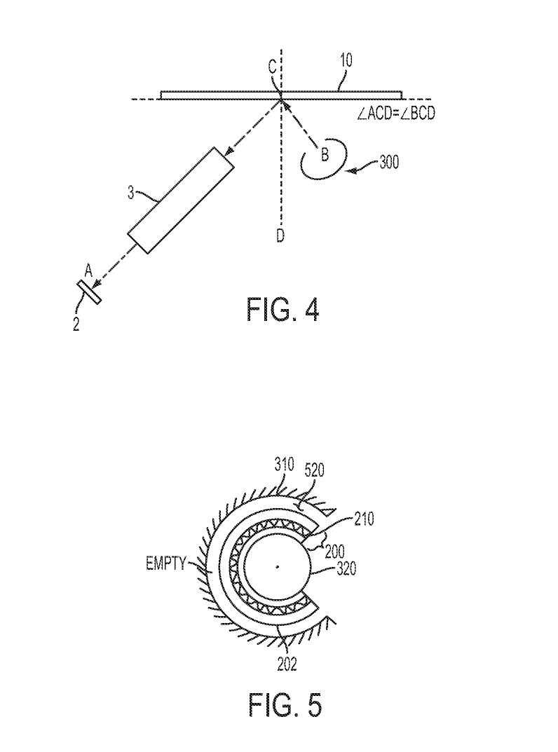

FIGS. 3A and 3B are a schematic projection view and a cross-sectional view along line 3A-3A of the illuminator of FIG. 3A, respectively, of an example of an illuminator 300 useful in illuminating an image bearing surface (shown in FIG. 4) of a copier or printer according to aspects of the present disclosure.

Illuminator 300 comprises a flexible sheet emitter 200, a reflecting surface 310 and at least one rigid element 320.

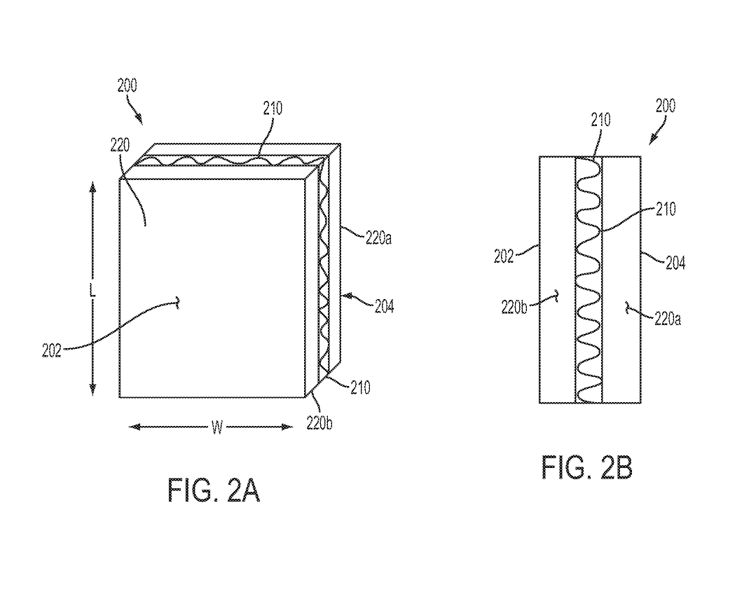

Referring to FIGS. 2A and 2B, flexible sheet emitter 200 includes an emitting layer 210 adapted to emit light. A sheet emitter for use in embodiments of the present disclosure may be any sheet emitter that emits light and can be arranged in a configuration as described herein. For example, the sheet emitter may be a flexible sheet emitter such as an organic light emitting diode (OLED). FIGS. 2A and 2B are a schematic projection view and a schematic, cross-sectional view, respectively, of an example of a flexible sheet emitter 200 having a width W and a length L for use in illuminators according to aspects of the present disclosure. Sheet 200 includes an emitting layer 210 from which light is emitted, and one or more additional layers 220a, 220b for electrical operation of the sheet and/or mechanical support of the emitting layer. The sheet emitter has a first face 202 and a second face 204 opposite the first face, the emitting layer and at least layer 220a being substantially transparent to the light that is emitted. Layer 220b may be substantially transparent to the light that is emitted. Further details of examples of OLED structures are given in U.S. Publ. Pat. Application 2013/0044487 by Burrows, et al. at paragraphs [0057] to [0065] the substance of which is hereby incorporated by reference herein. It will be appreciated that, in some embodiments according to the present disclosure, once a flexible emitter is installed in an illuminator the sheet may no longer be capable of being flexed, but rather is maintained in a single flexed state. Accordingly, the term “flexible sheet” as used herein includes a sheet that forms a curved surface as shown, even if the sheet emitter as installed is physically rigid.

Referring again to FIGS. 3A and 3B, reflecting surface 310 is shaped to form an optical cavity C for light emitted by the emitting surface. Reflecting surface 310 is adapted to diffusely reflect the light emitted by the emitting layer. Sheet emitter 200 is disposed in cavity C with first face 202 facing reflecting surface 310. Cavity C extends along a longitudinal axis LA. In cross section transverse to longitudinal axis LA, reflecting surface 310 has a non-closed shape along at least a portion of longitudinal axis LA thereby defining an aperture A through which the light emitted by the emitting surface exits cavity C. It is to be appreciated that, although in the illustrated embodiment, the sheet emitter is shown as having a layer 220b between the emitting layer 210 and reflecting surface 310, in some embodiments, layer 210 may be directly connected to reflecting surface 310 or layer 220b may comprise reflecting surface 310. It will be appreciated that, if layer 220b comprises the reflecting surface and the reflecting surface is the interior surface of layer 220b, layer 220b may be opaque light form the emitting layer.

The at least one rigid element 320 extends in the direction of longitudinal axis LA, with the sheet emitter being mechanically coupled to the at least one rigid element. In the illustrated embodiment, the rigid element has an element surface 322 to which the sheet emitter is mechanically coupled. In the illustrated embodiment, the element surface is an exterior surface of the rigid element, and second face 204 is facing element surface 322. By coupling the sheet emitter to the rigid element, directing of light from the emitting layer into the cavity C and out of aperture A is facilitated by suitably shaping the sheet emitter. Although the at least one rigid element is shown as a single piece, it may comprise two or more pieces that combine to facilitate directing of light.

Sheet emitter 200 may be connected to the at least one rigid element along an entire width W of the sheet emitter. The connection may occur along at least a portion of longitudinal axis LA or may occur along the entire longitudinal axis LA such that an entire surface of the sheet emitter is connected to the at least one rigid element. The sheet emitter may be connected to the at least one rigid elements continuously along the width W or at a plurality of discrete locations along width W.

The connection may be a direct connection (i.e., with no more than an adhesive between the sheet emitter and the rigid element) or with additional material between the sheet emitter and the rigid element.

In some embodiments, the shape of the element surface in cross section transverse to the longitudinal axis and, as a result of the mechanical coupling, and the shape of the sheet emitter in the cross section are substantially cylindrical, and in some embodiments, the cross sections of the element surface and the emitter surface are cylindrical; however, element surface and, as a result of the mechanical coupling, sheet emitter may have any suitable shape in cross section. It is to be appreciated that reflecting surface 310 forms the cavity and thereby may provide for an increase in radiance of the illuminator. The sheet emitter may extend 360 degrees around the longitudinal axis or may extend less than 360 degrees around the longitudinal axis. It will be appreciated that light from either face of the sheet emitter 202, 204 may reflect from the reflecting surface one or more times. Some light from the faces may exit aperture A without reflecting even once.

In some embodiments, the reflecting surface 310 in cross section transverse to the longitudinal axis LA is substantially cylindrical; however, reflecting surface 310 may have any suitable shape in cross section providing for reflecting of light from the emitting layer 210 and exiting of the light from aperture A. In some embodiments, reflecting surface 310 has a cylindrical cross section transverse to longitudinal axis LA.

FIG. 4 shows a schematic illustration of an image input module of a copier or a printer according to aspects of the present disclosure. The module includes an illuminator 300 or any other illuminator according to aspects of the present disclosure, a lens array 3, and a sensor array 2. The illuminator 300 is located on a line B-C and is configured to illuminate an image bearing surface 10. The light from the illuminator is incident on the image bearing surface 10 along a line extending into the paper in FIG. 4. The light incident at a representative point C along the line extending into the paper is reflected, thereby producing generally specular reflectance in a first direction along line C-A, and some generally diffuse reflectance. The angle between line A-C and normal line D-C (angle ACD) is substantially equal to the angle between line B-C and normal line D-C (angle BCD). As a result the sensor receives generally specular reflectance from illuminator 300 as the light reflects from the image bearing surface 10 at a specular reflectance angle along line A-C. The linear sensor array 2 as it captures the generally specular portion and the generally diffuse portion of the diffused light beam reflecting off the image bearing surface 10 at a specular reflectance angle at point C. Such a configuration provides full resolution images for both types of reflected light. Line C-D represents a normal line to the surface at a point C of the image bearing surface 10. Point C may actually be a line or a region on the surface of the image bearing surface 10.

Further embodiments of illuminators according to aspects of the present disclosure for use in copiers and printers in a manner similar to illuminator 300 are discussed below. In the embodiment illustrated in FIGS. 3A and 3B, the reflecting surface and the first face are directly connected together; however reflecting surface and first face, may be configured in any suitable manner (with or without mechanical connection or coupling) that provides optical coupling of the emitting layer to the reflecting surface, such that light from the emitting layer is directed into cavity C and out of aperture A. In some embodiments, one or more additional materials may be provided between the reflecting layer and the first face. Alternatively, as shown in FIG. 5, reflecting layer may be separated from one another by an air gap. The embodiment of FIG. 5 is similar to the embodiment of FIG. 3B in all regards except that there is a gap 520 between reflecting surface 310 and first face 202 of sheet emitter 200.

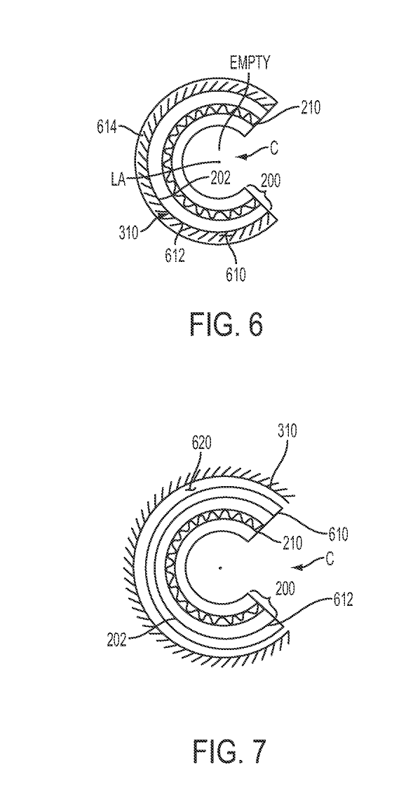

In the embodiment of FIG. 6, rigid element 610 has an element surface 612 to which the mechanically coupling of the sheet emitter occurs. In contrast to FIG. 3B, the element surface 612 is an interior surface of the rigid element. In this embodiment, the first face 202 of the emitting sheet is facing the element surface 612 and the reflecting surface 310 is disposed between the rigid element and the first face. The reflecting surface may be integrally formed with rigid element 610. Although the illustrated embodiment reflecting surface 310 is on the interior surface of the rigid element, if the rigid element is transparent to the light emitted by the emitting layer, the reflecting surface may be on an exterior element surface 614 of the rigid element or even separated from the rigid element by a gap 620 as shown in FIG. 7.

As in embodiments where the sheet emitter is connected to an exterior element surface of the rigid element, in embodiments where sheet emitter is connected to an interior element surface 612 of the rigid element, the element surface and the first face may be connected together. Sheet emitter 200 may be connected to the at least one rigid element along an entire width W of the sheet emitter. The connection may occur along at least a portion of longitudinal axis LA or may occur along the entire longitudinal axis LA such that an entire surface of the sheet emitter is connected to the at least one rigid element. The sheet emitter may be connected to the at least one rigid element continuously or at a plurality of discrete locations along width W of the emitting layer. The connection may be a direct connection (i.e., with no more than an adhesive between the sheet emitter and the rigid element) or with additional material between the sheet emitter and the rigid element 610.

In some embodiments, the shape of element surface 612 in cross section transverse to the longitudinal axis LA and, as a result of the mechanical coupling, the shape of the sheet emitter are substantially cylindrical. In some embodiments, the shape of the element surface 612 in cross section transverse to longitudinal axis LA and the shape of the sheet emitter surface are cylindrical. However, the shape of element surface in cross section transverse to longitudinal axis LA and, as a result of the mechanical coupling, sheet emitter may have any suitable shape in cross section. It is to be appreciated that reflecting surface 310 forms the cavity C and thereby may provide for an increase in radiance of the illuminator. The sheet emitter and emitting layer may extend 360 degrees around the longitudinal axis or may extend less than 360 degrees around the longitudinal axis LA. The sheet emitter and emitter layer may be angularly coextensive with the reflecting surface relative to longitudinal axis LA or may be of smaller angular extent than the reflecting surface.

In some embodiments, the reflecting surface 310 in cross section transverse to the longitudinal axis LA is substantially cylindrical, however, reflecting surface may have any suitable shape in cross section providing for reflecting of light from the emitting layer and exiting of the light from aperture A. In some embodiments, the reflecting surface has a cylindrical cross section transverse to longitudinal axis LA.

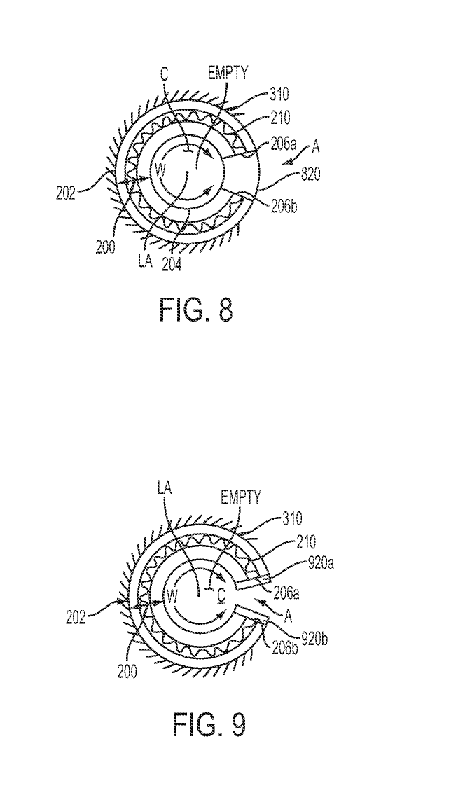

FIGS. 8 and 9 are additional embodiments of illuminators according to aspects of the disclosure for illuminating an image bearing surface, comprising a sheet emitter 200 to produce light, a reflecting surface 310 shaped to form an optical cavity C for the light, the reflecting surface adapted to diffusely reflect the light, and at least one rigid element 820, 920a, 920b extending in the direction of the longitudinal axis LA, the sheet emitter being mechanically coupled to the at least one rigid element to facilitate directing of the light from the emitting layer into the cavity and out of the aperture A.

In the embodiment of FIG. 8, the rigid element 820 is not connected to a face 202, 204 of the sheet emitter along a width of the sheet emitter. Rather, the at least one rigid element is mechanically coupled to at least a portion of an end 206a, 206b of the sheet emitter. The rigid element may be connected to the ends of the sheet emitter, either directly or indirectly or may be coupled in any manner suitable to facilitate formation of a cavity, directing of light from the emitting layer into the cavity C and out of aperture A. As show in FIG. 9, the at least one rigid element may comprise two rigid elements 920a, 920b one coupled to each end 206a, 206b of sheet emitter. In the embodiments shown in FIG. 8, the rigid element may be transparent to light from the sheet emitter or the element may be at selected locations along the longitudinal axis to permit the light to exit the aperture without traveling though the rigid element.

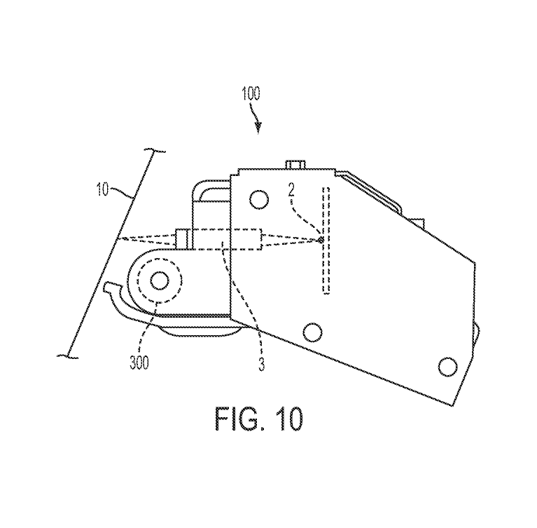

FIG. 10 is a schematic illustration of a printer or copier including an illuminator according to aspects of the present, the printer or a copier system comprising an illumination apparatus comprising any illuminator (e.g., illuminator 300) according to aspects of the present disclosure as described herein. The size and location of the illuminator are determined in part by the size available in the printer or copier. It will be appreciated that the width of the sheet emitter and location of the illuminator are typically selected to provide an irradiance of an image bearing that is greater than the irradiance than would be provide at the image bearing surface by flat sheet emitter of the same size. Such a configuration can be selected using data as set forth and discussed with reference to FIG. 1C above. Image input module 100 includes a lens array 3, and a sensor array 2.

In an embodiment, an image bearing surface 10 used in the system is on a photoreceptor comprising a belt or a drum configuration. However, it may also be the printed document, or any other surface bearing an image.

Lens array 3 is interposed between the image bearing surface 10 and the sensor array 2. The lens array may comprise, for example, a Selfoc® lens or other micro lens arrangement with a predetermined acceptance angle β. A Selfoc® lens is a gradient index lens which consists of fiber rods with parabolic index profile. In one embodiment, the Selfoc® lens has an acceptance angle β of about ±9 degrees.

In some embodiments, the linear array sensor is, for example, a full width array (FWA) sensor. A full width array sensor is defined as a sensor that extends substantially an entire width (perpendicular to a direction of motion) of the moving image bearing surface. The full width array sensor is configured to detect any desired part of the printed image, while printing real images. The full width array sensor may include a plurality of sensors equally spaced at intervals (e.g., every 1/600th inch (600 spots per inch)) in the cross-process (or fast scan) direction (see for example, U.S. Pat. No. 6,975,949, which is hereby incorporated by reference herein). It is understood that other linear array sensors may also be used, such as contact image sensors, CMOS array sensors or CCD array sensors.

In some embodiments, sensor array 2 includes a specular reflectance sensor array and a diffuse reflectance sensor array as discussed in detail in U.S. Pat. No. 7,763,876 to Banton, et al. which is hereby incorporated by reference herein.

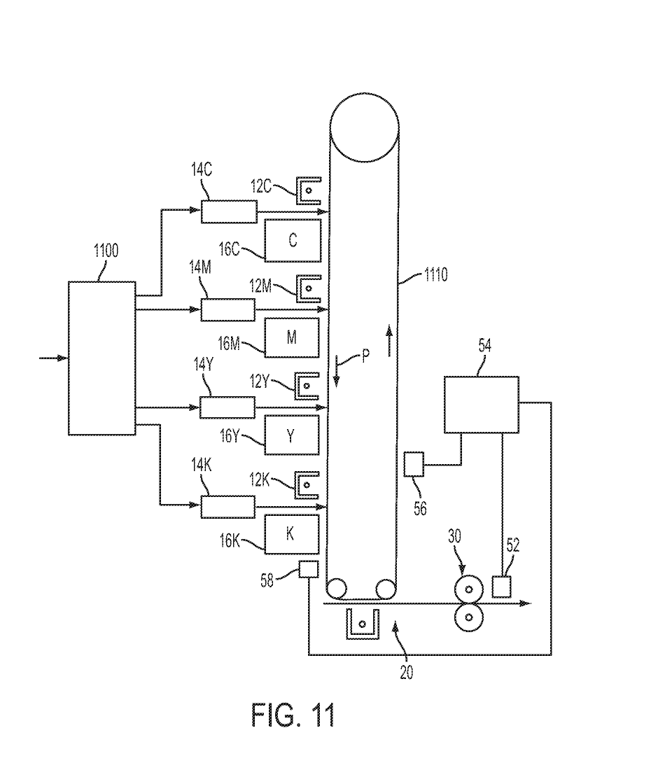

FIG. 11 is a simplified schematic view of basic elements of a color printer, comprising an illuminator as described herein according to the present disclosure. Specifically, there is shown an “image-on-image” xerographic color printer, in which successive primary-color images are accumulated on a photoreceptor belt, and the accumulated superimposed images are in one step directly transferred to an output sheet as a full-color image. In one implementation, the Xerox Corporation iGen3® digital printing press may be utilized. However, it is appreciated that any printing machine, such as monochrome machines using any technology, machines which print on photosensitive substrates, xerographic machines with multiple photoreceptors, or ink-jet-based machines, can beneficially utilize the present disclosure as well.

Specifically, the FIG. 11 embodiment includes a belt photoreceptor 210, along which are disposed a series of stations, as is generally familiar in the art of xerography, one set for each primary color to be printed. For instance, to place a cyan color separation image on photoreceptor 210, there is used a charge corotron 12C, an imaging laser 14C, and a development unit 16C. For successive color separations, there is provided equivalent elements 12M, 14M, 16M (for magenta), 12Y, 14Y, 16Y (for yellow), and 12K, 14K, 16K (for black). The successive color separations are built up in a superimposed manner on the surface of photoreceptor 210, and then the combined full-color image is transferred at transfer station 20 to an output sheet. The output sheet is then run through a fuser 30, as is familiar in xerography.

Also shown in the FIG. 11 is a set of what can be generally called “monitors,” such as 56, 52, and 58, which can feed back to a control device 54. The monitors such as 56, 52, and 58 are devices which can make measurements to images created on the photoreceptor 210 (such as monitor 58) or to images which were transferred to an output sheet (such as monitor 52). These monitors can, for example, be in the form of optical densitometers such as image input modules comprising illuminators as described herein. There may be provided any number of monitors, and they may be placed anywhere in the printer as needed, not only in the locations illustrated. The information gathered therefrom is used by control device 54 in various ways to aid in the operation of the printer, whether in a real-time feedback loop, an offline calibration process, a registration system, etc.

Typically, a printer using control systems which rely on monitors such as 56, 52, and 58 require the deliberate creation of what shall be here generally called “test patches” which are made and subsequently measured in various ways by one or another monitor. These test marks may be in the form of test patches of a desired darkness value, a desired color blend, or a particular shape, such as a line pattern; or they may be of a shape particularly useful for determining registration of superimposed images (“fiducial” or “registration” marks). Various image-quality systems, at various times, will require test marks of specific types to be placed on photoreceptor 210 at specific locations. These test marks will be made on photoreceptor 210 by one or more lasers such as 14C, 14M, 14Y, and 14K. Printing process may be controlled, for example, by a print controller 200.

A calibration procedure could be determined so that the signals from the linear sensor array 2 can be used to work out the true specular reflectance and the difference between the specular and diffuse reflectances of the image being measured. For example, the amount of diffuse light being reflected at the specular angle is determined and the subsequent specular sensor readings are corrected by subtracting a fraction of the diffuse sensor signal from the specular sensor signal as discussed in U.S. Pat. No. 8,010,001, herein incorporated by reference.

As is familiar in the art of “laser printing,” by coordinating the modulation of the various lasers with the motion of photoreceptor 210 and other hardware (such as rotating mirrors, etc., not shown), the lasers discharge areas on photoreceptor 210 to create the desired test marks, particularly after these areas are developed by their respective development units 16C, 16M, 16Y, 16K. The test marks must be placed on the photoreceptor 210 in locations where they can be subsequently measured by a (typically fixed) monitor elsewhere in the printer, for whatever purpose.

In an embodiment, the image input module 100, as described above, can be placed just before or just after the transfer station 20 where the toner is transferred to the sheet, for example, on monitors such as 58, 56. In another embodiment, the image input module 100, may be placed directly on a printed sheet as the printed sheet comes out of the machine, for example, on a monitor such as monitor 52.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

1. An illuminator useful in illuminating an image bearing surface, comprising:
a flexible sheet emitter including an emitting layer, the emitting layer adapted to emit light, the sheet emitter having a first face and a second face opposite the first face, the emitting layer being substantially transparent to the light;
a reflecting surface shaped to form an optical cavity for the light, the reflecting surface adapted to diffusely reflect the light, the sheet emitter being disposed in the cavity with the first face facing the reflecting surface, the cavity extending along a longitudinal axis, in cross section transverse to the longitudinal axis, the reflecting surface having a non-closed shape along at least a portion of the longitudinal axis thereby defining an aperture through which the light exits the cavity; and
at least one rigid element extending in the direction of the longitudinal axis, the sheet emitter being mechanically coupled to the at least one rigid element to facilitate directing of light from the emitting layer into the cavity and out of the aperture.

2. The illuminator of claim 1, wherein the sheet emitter is connected to the at least one rigid element.

3. The illuminator of claim 1, wherein the sheet emitter is connected to the at least one rigid element along an entire width of the sheet emitter, the connection occurring along at least a portion of the longitudinal axis.

4. The illuminator of claim 2, wherein the connection is a direct connection.

5. The illuminator of claim 1, wherein the sheet emitter extends less than 360 degrees around the longitudinal axis.

6. The illuminator of claim 1, wherein the sheet emitter is connected to one of the at least one rigid elements at a plurality of discrete locations along a width of the sheet emitter.

7. The illuminator of claim 1, wherein the sheet emitter is an OLED emitter.

8. The illuminator of claim 1, wherein the at least one rigid element has an element surface having a substantially cylindrical cross section transverse to the longitudinal axis, the mechanical coupling of the sheet emitter being to the element surface.

9. The illuminator of claim 8, wherein the element surface is cylindrical.

10. The illuminator of claim 1, wherein the reflecting surface has a substantially cylindrical cross section transverse to the longitudinal axis.

11. (canceled)

12. The illuminator of claim 1, wherein the at least one rigid element has an element surface to which the mechanically coupling of the sheet emitter occurs, the element surface being an exterior surface of the at least one rigid element, the second face facing the element surface.

13. The illuminator of claim 12, wherein the element surface and the second face are directly connected together.

14. The illuminator of claim 12, wherein the reflecting surface and the first face are directly connected together.

15. The illuminator of claim 12, wherein the at least one rigid element has a substantially cylindrical cross section and the reflecting surface has a substantially cylindrical cross section.

16. The illuminator of claim 1, wherein the at least one rigid element has an element surface to which the mechanically coupling of the sheet emitter occurs, the element surface being an interior surface of the at least one rigid element, the first face facing the element surface.

17. The illuminator of claim 16, wherein the element surface and the first face are directly connected together.

18. The illuminator of claim 16, wherein the reflecting surface and the first face are directly connected together.

19. The illuminator of claim 16, wherein the at least one rigid element has a substantially cylindrical cross section and the reflecting surface has a substantially cylindrical cross section.

20. A printer or electronic copier, comprising:
a print engine configured to apply a marking medium to an image bearing surface;
a system for illuminating the image bearing surface in the printer or electronic copier, the system comprising:
(i) an illuminator, comprising (a.) a flexible sheet emitter including an emitting layer, the emitting layer adapted to emit light, the sheet emitter having a first face and a second face opposite the first face, the emitting layer being transparent to the light, (b.) a reflecting surface shaped to form an optical cavity for the light, the reflecting surface adapted to diffusely reflect the light, the sheet emitter being disposed in the cavity with the first face facing the reflecting surface, the cavity extending along a longitudinal axis, in cross section transverse to the longitudinal axis, the reflecting surface having a non-closed shape along at least a portion of the longitudinal axis thereby defining an aperture through which the light exits the cavity, and (c.) at least one rigid element extending in the direction of the longitudinal axis, the sheet emitter being mechanically coupled to the at least one rigid element to facilitate directing of light from the emitting layer into the cavity and out of the aperture; and
(ii) a light sensor positioned relative to the image bearing surface such that at least one of a specular portion and a diffuse portion of the light reflecting from the image bearing surface is received by the light sensor.
